(19) United States
(12) Patent Application Publication
(10) Pub. No.: US 2013/0008849 A1
(43) Pub. Date: Jan. 10, 2013

(54) Device for Folding a Web-Shaped Filter Medium and Method for Producing a Filter Element Folded in a Zigzag Shape

(75) Inventors: Klaus Gehwolf, Mamming (DE); Christian Geiger, Reisbach (DE)

(73) Assignee: MANN+HUMMEL GMBH, Ludwigsburg (DE)

(21) Appl. No.: 13/614,202

(22) Filed: Sep. 13, 2012

Related U.S. Application Data
(63) Continuation of application No. PCT/EP2011/054003, filed on Mar. 16, 2011.

(30) Foreign Application Priority Data
Mar. 17, 2010 (DE) 10 2010 011 785.4

(51) Int. Cl. B31B 1/26; B01D 46/00; B01D 29/00

(52) U.S. Cl. 210/493.5; 493/405

(57) ABSTRACT

A device for folding a web-shaped filter medium of a filter element has an energy-introducing embossment unit and a feed device that feeds a web-shaped filter medium to the embossing unit where folding lines are embossed into the web-shaped filter medium. A folding device is provided that folds the web-shaped filter medium along the folding lines. The energy-introducing embossment unit is provided to fuse layers of the multi-layer filter medium along the folding lines during embossment of the folding lines.

### CROSS REFERENCE TO RELATED APPLICATIONS

This application is a bypass continuation application of international application No. PCT/EP2011/054003 having an international filing date of 16 Mar. 2011 and designating the United States, the International Application claiming a priority date of 17 Mar. 2010, based on prior filed German patent application No. 10 2010 011 785.4, the entire contents of the aforesaid international application and the aforesaid German patent application being incorporated herein by reference.

### TECHNICAL FIELD

The invention concerns a device for folding a web-shaped filter medium of a filter element, in particular of a motor vehicle. The device comprises a feed device for the web-shaped filter medium, comprises an energy-introducing embossment unit, in particular an ultrasonic embossment unit for embossing folding lines of the web-shaped filter medium, and comprises a folding device for folding the web-shaped filter medium along the folding lines.

Moreover, the invention concerns a method for producing a zigzag-shaped folded filter element, in particular of a motor vehicle, from a web-shaped filter medium in which the web-shaped filter medium is supplied by a feed device to an energy-introducing embossment unit, in particular an ultrasonic embossment unit, by means of which folding lines are embossed into the web-shaped filter medium, and the filter medium is subsequently folded along the folding lines by means of a folding device.

Moreover, the invention concerns a filter element.

### BACKGROUND OF THE INVENTION

WO 98/17573 discloses a device for folding a web-shaped filter medium. The filter medium is supplied from a roll to an embossment unit. The embossment unit is comprised of two anvil rollers and two sonotrodes as a part of a so-called oscillating unit. The sonotrodes emboss the filter medium as the filter medium passes through at the locations provided therefore so that subsequently a folding action can be carried out.

Recently, also multi-layer web-shaped filter media have been used that are folded to filter elements. In order to prevent that the layers of the filter medium in the finished filter element become detached from each other, in known multi-layer filter media the layers are connected to each other in a separate working step before embossment and folding. The thus connected layers however can no longer be moved relative to each other even during the embossment process and the folding process. This makes the folding action of multi-layer filter media more difficult.

### SUMMARY OF THE INVENTION

An object of the invention is to design a device and a method of the aforementioned kind such that multi-layer web-shaped filter media can be folded in a simple and precise way, wherein the layers in the finish-folded filter element are connected to each other in a stable way.

This object is solved according to the invention in that the energy-introducing embossment unit, in particular ultrasonic embossment unit, is embodied for fusing or welding the layers of the multi-air filter medium during the embossment action along the folding lines.

According to the invention, the energy-introducing embossment unit is thus designed such that it simultaneously embosses the filter medium along the folding lines and fuses (welds) the layers together at the folding lines. The filter medium is in this way permanently laminated along the folding lines, in particular so as to be robust with regard to environmental effects. In this way, the stability of the filter medium in the folded state is increased. Moreover, by the defined and stable connection of the layers along the folding lines, the subsequent folding action is facilitated and improved. In particular, the layers are fused to each other in such a way that the composite strength at the connecting or fusing lines of the layers is at least as great as the material strength within the individual layers.

Preferably, as an energy-introducing embossment unit, an ultrasonic embossment unit is used. However, the energy can also alternatively be introduced by means of a thermo-calender, a laser, or other energy sources.

In an advantageous embodiment, it may be provided that the layers of the multi-layer filter media are not connected to each other prior to embossment. In this way, a prior working step for connecting the layers, in particular lamination of the layers, can thus be eliminated. The layers are resting up to the point of the embossment process flat and loose on each other in a stress-free state and are slidable relative to each other. Tension or stress between the layers that may occur upon embossment and upon folding of the layers are thus compensated in a simple way. Accordingly, the embossment process and the folding process are simplified.

In a further advantageous embodiment, downstream of the ultrasonic embossment unit there is arranged an erecting unit for zigzag-shaped folding of the web-shaped filter medium. The filter medium can be directly folded by means of the erecting unit subsequent to embossing and fusing. In this way, the layers can align themselves in a simple way after each embossment of a folding line in order to decrease or remove tension or stress; this further simplifies the folding process and increases precision.

Advantageously, at least one of the layers of the multi-layer filter medium can be a mesh or netting, in particular a plastic netting. Netting increases the stability of the filter medium. Plastic can be simply heated, embossed, and fused with the other layers by means of the embossment unit.

Moreover, advantageously at least one of the layers of the multi-layer filter medium may comprise a meltblown layer. Because of the three-dimensional storage structure of the meltblown layer, an excellent filtration performance is achieved; this increases the service life of the filter element. Meltblown layers can be simply shaped, embossed, and fused.

In one embodiment, in the filter medium a prefilter layer and a fine filter layer are joined together in the flow direction, wherein at the raw (unfiltered fluid) side of the prefilter layer a first support layer and at the clean (filtered fluid) side of the fine filter layer a second support layer are provided for compensating longitudinal or transverse forces in case of tensile load or compression load, wherein the two support layers each have different mean maximum tensile forces in the longitudinal or transverse direction. The longitudinal direction is defined as the direction in which the particularly web-shaped and preferably rectangular filter medium has its greatest length; in particular, it is the feed direction during production of the filter medium. The transverse direction is defined as the direction which extends along the width of the filter medium, perpendicular to the longitudinal direction, and along which the filter medium is preferably folded.

The different strengths have the advantage that thereby in longitudinal and transverse directions the length difference of the outer layers about the neutral layer at the center are compensated in case of possible deflections during the laminating, roll-cutting, embossing, and erecting process and, in this way, the processibility is improved or is even made possible in case of certain configurations. The stiffness needed for connecting the folded bellows and the end disk of the filter element, this stiffness being required for fusing the filter medium to a thermoplastic end disk or for immersing the filter medium into a viscous adhesive, is advantageously achieved by means of the support layer for compensating the transverse forces.

Moreover, the support layers in an appropriate embodiment can advantageously fulfill a drainage function in order to prevent the filter medium from sticking together. A further advantage of the support layers resides in the possibility to be able to move the folds to form a “block” because in this way the support layers resting on each other ensure that flow though the filter element is maintained.

When carrying out measurements for determining the properties in case of tensile load, generally separately for the processing direction (longitudinal direction) and the transverse direction, the width-related fracture force according to DIN EN ISO 1924-2 is determined based on the following equation:

$${σ}_{T}^{b} = \frac{{\overline{F}}_{t}}{b}$$

wherein F̅ₜ is the mean value of the maximum tensile force in Newton and b is the initial width of the sample in mm According to standard, b=15 mm and the length of the sample is at least 180 mm For determining the mean maximum tensile force at least 10 tests are required. In the following, as characteristic value of the material, the mean value of the maximum tensile force in Newton F̅ₜ is indicated. Since according to standard the width b of 15 mm is a fixed experimental parameter, it is possible to calculate based thereon at any time the width-related fracture force.

As a further characteristic value of the material, in the following the width-related bending stiffness S determined according to DIN 53121 is used. The standard provides different measuring methods; preferably, a rectangular sample of the width b is clamped along the width and, at a spacing 1 from the clamping location, is loaded with a force F so that a maximum bending f as a displacement of the point of attack of the force results. The width-related bending stiffness S is calculated as follows:

$$S = \frac{F}{f} * \frac{{l}^{3}}{3 b}$$

In one embodiment, the mean maximum tensile force of the support layer of the filter element that absorbs the transverse forces of the filter medium is greater than 10 N in longitudinal direction.

In an advantageous embodiment, the mean maximum tensile force of the support layer of the filter medium that absorbs the transverse forces is greater than 20 N in the transverse direction.

In one embodiment, the mean maximum tensile force of the support layer of the filter medium absorbing the longitudinal forces is greater than 20 N in the longitudinal direction.

In an advantageous embodiment, the mean maximum tensile force of the support layer of the filter medium absorbing the longitudinal forces is greater than 10 N in the transverse direction.

In one embodiment, the width-related bending stiffness of the support layer of the filter medium that absorbs the transverse forces is greater than 0.1 N@mm, in particular greater than 0.15 N@mm, in longitudinal direction.

In one embodiment, the width-related bending stiffness of the support layer of the filter medium that absorbs the transverse forces is greater than 0.3 N@mm, in particular greater than 0.4 N@mm, in the transverse direction.

In an advantageous embodiment, the width-related bending stiffness of the support layer of the filter medium that absorbs the longitudinal forces is greater than 0.3 N@mm, in particular preferred greater than 0.45 N@mm, in longitudinal direction.

In one embodiment, the width-related bending stiffness of the support layer of the filter medium that absorbs the longitudinal forces is greater than 0.1 N@mm, in particular preferred greater than 0.15 N@mm, in transverse direction.

In one embodiment, the support layers each are in the form of a netting or mesh comprised of crossing threads, wherein the crossing threads define a thread angle.

In one embodiment, the thread angle of the support layer of the filter medium that is provided for absorbing the transverse forces is in the range of 70 degrees to 120 degrees, especially preferred in the range of 80 degrees to 100 degrees, in particular preferred 90 degrees.

In one embodiment, the thread angle of the support layer of the filter medium that is provided for absorbing the longitudinal forces is in the range of 40 degrees to 80 degrees, in particular in the range of 50 degrees to 70 degrees.

In one embodiment, the prefilter layer of the filter medium is comprised of a meltblown layer with thickness in the range of 0.1 mm to 1 mm and a weight per surface area in the range of 40 grams per square meter to 200 grams per square meter.

In one embodiment, the thickness of the meltblown layer of the filter medium is between 0.2 mm and 0.4 mm and the weight per surface area is between 90 grams per square meter and 110 grams per square meter.

In one embodiment, the fiber diameter of the prefilter layer and/or the fine filter layer of the filter medium is in the range of 0.1 micrometer to 10 micrometer.

In one embodiment, the prefiltered layer and/or the fine filter layer of the filter medium are produced from materials selected from the group consisting of polybutyl terephthalate (PBT) meltblown, polyamide (PA) meltblown, polypropylene (PP) meltblown, and polyether sulfone (PES) meltblown.

In one embodiment, the fine filter layer of the filter medium is formed of a meltblown layer with a thickness in the range of 0.5 mm to 1.5 mm and a weight per surface area in the range of 40 grams per square meter to 200 grams per square meter.

In one embodiment, the thickness of the meltblown layer of the filter medium is between 0.6 mm and 1.0 mm and the weight per surface area is between 90 grams per square meter and 110 grams per square meter.

In one embodiment, the filter medium has additionally a third filter layer.

In one embodiment, the third filter layer of the filter medium is formed of a meltblown layer with a thickness in the range of 0.1 mm to 1 mm and a weight per surface area in the range of 10 g per square meter to 100 g per square meter.

In one embodiment, the thickness of the meltblown layer of the filter medium is between 0.2 mm and 0.4 mm and the weight per surface area is between 30 grams per square meter and 60 grams per square meter.

In one embodiment, the third filter layer of the filter medium is made of materials selected from the group consisting of polybutyl terephthalate (PBT) meltblown, polyamide (PA) meltblown, polypropylene (PP) meltblown, and polyether sulfone (PES) meltblown.

In one embodiment, the fiber diameter of the third filter layer of the filter medium is in the range of 0.1 micrometer to 10 micrometer.

In one embodiment, the third filter layer is embodied as an absolute separator.

In one embodiment, the support layers are comprised of a combination selected from the group consisting of mesh spunbond, spunbond-spunbond, spunbond filter layers, and mesh filter layers.

In a further advantageous embodiment, the ultrasonic embossment unit can comprise an anvil roller with embossment webs, an ultrasound-operated sonotrode and an embossment punch that in particular is formed at least partially by the sonotrode. In this way, with a simple continuous method the web-shaped filter medium can be embossed and fused in a single working step along the folding lines.

Advantageously, in the transport direction of the filter medium before and behind the anvil roller a nip roller, in particular a driven nip roller, can be arranged. The positions of the nip rollers relative to the anvil roller are changeable in order to adjust an inlet angle and outlet angle at the anvil roller. Driven nip rollers furthermore can serve for transporting the filter medium webs. Advantageously, the speed of the nip rollers can be adjusted. The nip rollers can be adjusted with respect to position and/or speed to the properties of the filter medium web, in particular material composition, layer thicknesses and/or dimensions, in order to enable optimal embossment and fusing.

In accordance with the invention, the object is further solved with regard to the method in that the layers of the multi-layer filter medium during embossment are fused along the folding lines. The advantages that have been discussed above in connection with the device according to the invention also apply likewise to the method of the invention and its advantageous embodiments.

In an advantageous embodiment of the method, the filter medium can be embossed and fused by means of an anvil roller with embossment webs, an ultrasound-operated sonotrode and an embossment punch that in particular is formed at least partially by the sonotrode.

Advantageously, the multi-layer filter medium, after embossment and fusing, can be folded by means of an erecting unit in a zigzag shape.

The object is further solved by a filter element produced with the device according to the invention and/or the method according to the invention.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

Features of the present invention, which are believed to be novel, are set forth in the drawings and more particularly in the appended claims. The invention, together with the further objects and advantages thereof, may be best understood with reference to the following description, taken in conjunction with the accompanying drawings. The drawings show a form of the invention that is presently preferred; however, the invention is not limited to the precise arrangement shown in the drawings.

FIG. 1 shows schematically a device according to the invention in a first embodiment for zigzag-shaped folding of a three-layer filter medium web;

FIG. 2 shows schematically a detail view of an ultrasonic embossment unit of the device according to FIG. 1;

FIG. 3 shows schematically a detail view of the filter medium web that has been embossed and fused with the ultrasonic embossment unit of FIG. 2;

FIG. 4 is an isometric illustration of a folded zigzag-shaped filter element that has been produced with the device of FIG. 1;

FIG. 5 shows a detail view of the filter element of FIG. 4; and

FIG. 6 shows schematically a device according to a second embodiment of the invention for zigzag-shaped folding of a three-layer filter medium web, which device is similar to that of the first embodiment of FIG. 1.

In the Figures, the same components are referenced with the same reference numerals. Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

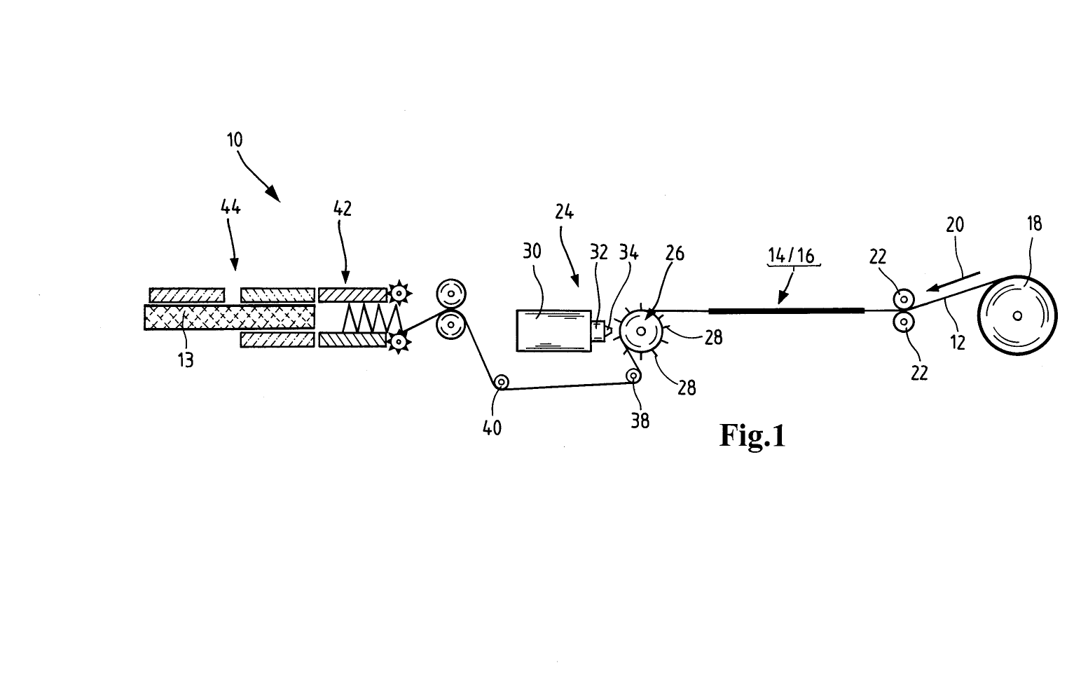

In FIG. 1 a device 10 for zigzag-shaped folding of a multi-layer filter medium web 12 of filter element 13 is illustrated.

The filter element 13 is used for filtering liquid or gaseous fluids, for example, motor oil, fuel, combustion air or compressed air in motor vehicles.

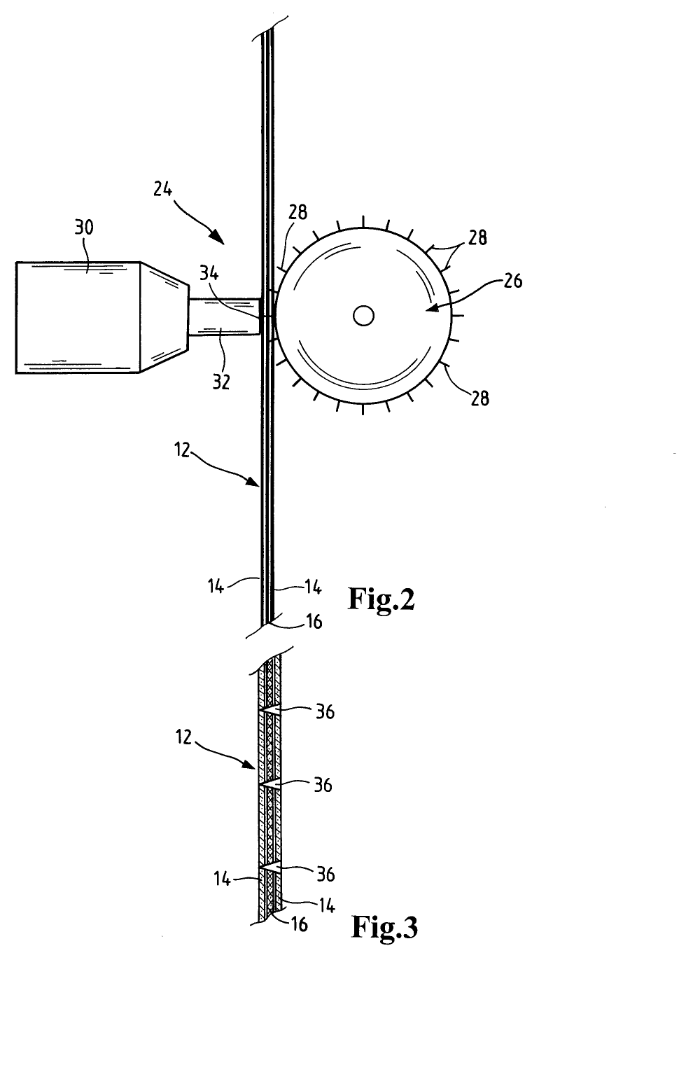

The filter medium web 12 is comprised, as shown in FIGS. 2 and 3, of three layers that are initially loosely resting on each other. The two outer layers are comprised of plastic mesh or netting 14. Between the plastic mesh 14 a meltblown layer 16 is arranged that forms the middle layer. Alternative embodiments provide two or more such layers.

The endless filter medium web 12 is removed from a roll 18 in conveying direction, indicated by arrow 20, and is passed through between the two transport rollers 22. Without having been heated prior to this, the filter medium web 12 is supplied to an ultrasonic embossment unit 24.

The ultrasonic embossment unit 24 comprises an anvil roller 26 which is provided circumferentially with a plurality of embossment webs 28. The embossment webs 28 are distributed at uniform or non-uniform spacing relative to each other about the circumference of the anvil roller 26. They each extend axially relative to the anvil roller 26 and project in radial direction. The width of the web 28 in the circumferential direction is approximately 1 mm, respectively. The radial outer surfaces of the embossment webs 28 are smooth. By non-uniform spacing of the embossment webs 28, it is possible to create different fold heights.

Moreover, the ultrasonic embossment unit 24 comprises an ultrasonic unit 30 by means of which ultrasound is introduced into a sonotrode 32 in a way that is not important in this connection. The ultrasonic unit 30 with the sonotrode 32 is located adjacent to the anvil roller 26. The sonotrode 32 forms an embossment punch that interacts with the embossment webs 28 of the anvil roller 26.

The filter medium web 12 is passed through between the anvil roller 26 and the sonotrode 32. In the transport or conveying direction 20 in front of the anvil roller 26, the plastic mesh 14 and the meltblown layers 16 can move relative to each other. In this way, mechanical tension or stress between the layers is decreased or eliminated.

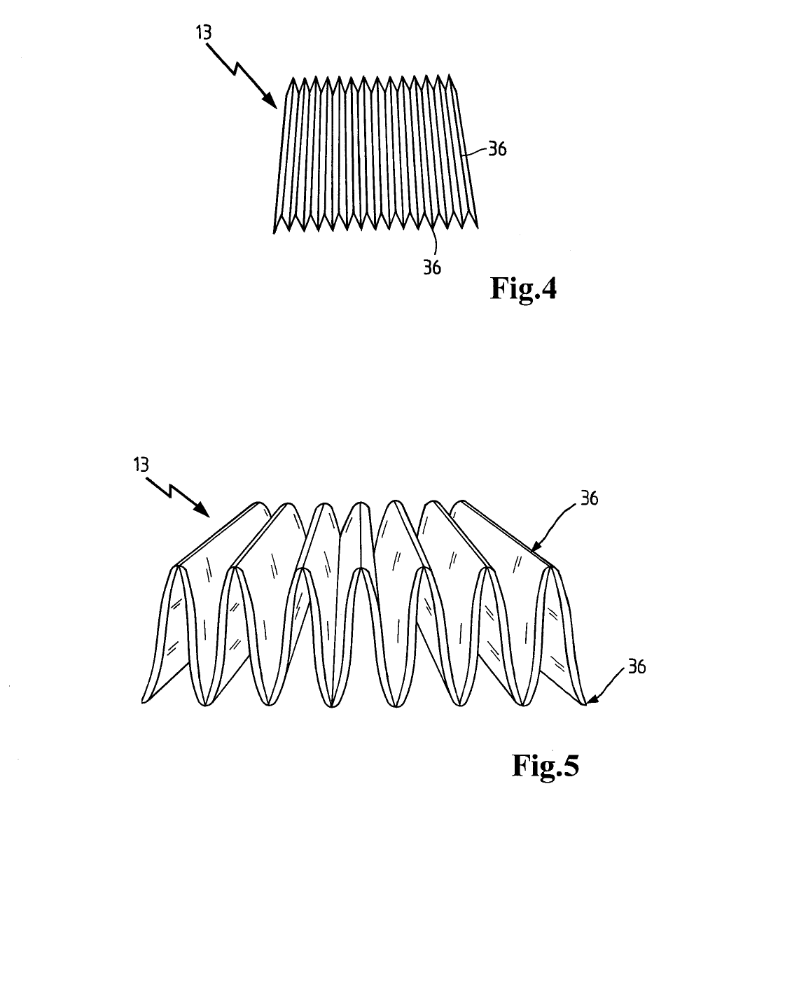

During transport of the filter medium web 12 through the ultrasonic embossment unit 24, the introduction of ultrasound at the tip 34 of the sonotrode 32 causes heat development at the filter medium web 12 in the areas defined by the embossment webs 28. The thus embossed areas form folding lines 36 for the subsequent folding process of the filter medium web 12. The folding lines 36 are shown in FIG. 3 in detail and also shown in a finished filter element 13 in FIGS. 4 and 5.

The height of the embossment webs 28 in radial direction, the spacing between the tip 34 of the sonotrode 32 and the embossment webs 28 and the energy that is transferred by means of the sonotrode 32 onto the filter medium web 12 are matched to the properties of the filter medium web 12, for example, the material type, the layer thicknesses and the total thickness, in order to fuse, simultaneously with embossing, the plastic mesh 14 and the meltblown layers 16 by means of the sonotrode 32 along the folding line 36.

Between the folding lines 36, the plastic mesh 14 and the meltblown layers 16 are not connected to each other and can still align themselves relative to each other. Mechanical tension in the embossed and fused filter medium web 12 can thus be decreased or eliminated during the subsequent folding process in a more simple way so that an undesirable fold formation between the folding lines 36 can be avoided and the folding process can be carried out in a simpler and more precise way. Moreover, it is avoided in this way that the plastic mesh 14 and the meltblown layer 16 during the folding process are lifted off each other and separated. The use of a single sonotrode 32 contributes in this context to avoidance of mechanical tension and folds in the filter medium web 12.

In the conveying direction 20 behind the ultrasonic embossment unit 24 the embossed and fused filter medium web 12 is supplied via a deflecting roller 38 and a deflecting roller 40 at room temperature to an erecting unit 42. In the erecting unit 42 the filter medium web 12 is folded to a zigzag shape in a way that is not of interest in this context and is then cut to form filter elements 13.

The filter elements 13 are subsequently supplied to a fold tip heating device 44, not of interest in this connection, and heated.

Folding speeds of 700 folds per minute and more can be achieved with the device 10.

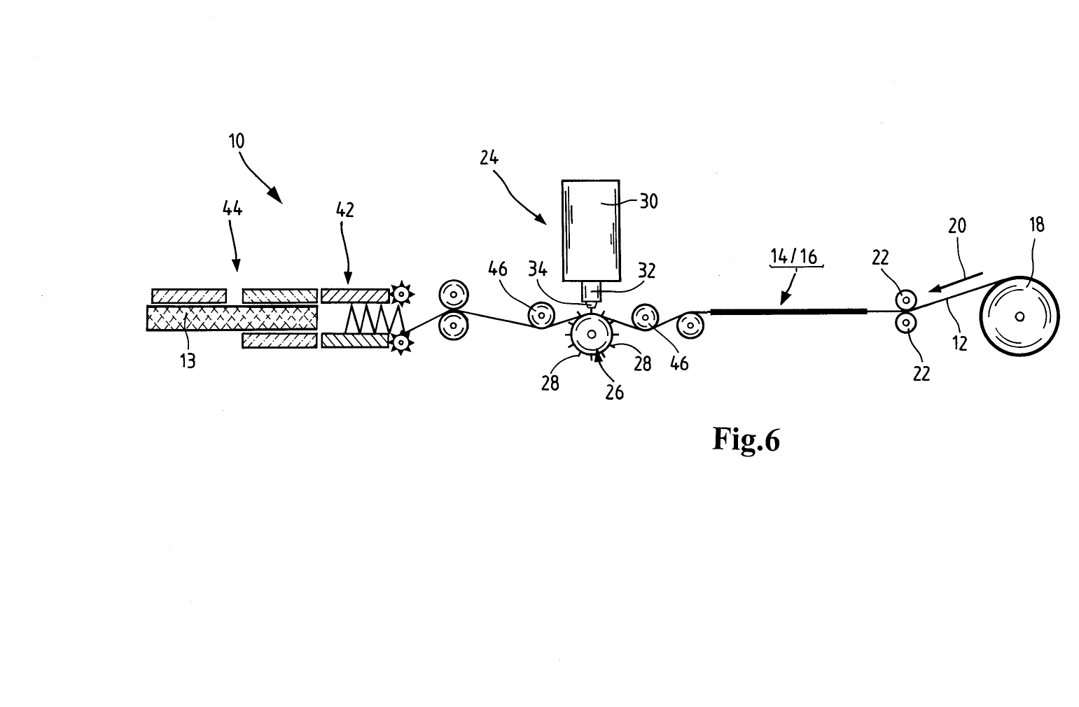

In a second embodiment, illustrated in FIG. 6, those elements that are similar to those of the first embodiment illustrated in FIGS. 1 through 5, are provided with same reference numerals. With respect to these elements, reference is being had to the description and discussion of the first embodiment.

The second embodiment differs from the first in that in the conveying direction 20 before and behind the anvil roller 26 additionally a rotatingly driven nip roller 46 is arranged, respectively, that serves for transporting the filter medium web 12. The deflection rollers 38 and 40 are eliminated here. Moreover, in the second embodiment, the ultrasonic unit 30 with the sonotrode 32 is arranged above the anvil roller 26.

The nip rollers 46 are adjustable with respect to their vertical position relative to the anvil roller 26 so that by means of this adjustability an inlet angle and an outlet angle across the anvil roller 26 can be adjusted. The positions and speeds of the nip rollers 46 are adjusted depending on the properties of the filter medium web 12 in such a way that an optimal embossment, fusing and folding is realized. For some media non-driven nip rollers may be advantageous also.

In all of the above described embodiments of a device 10 and a method for producing a zigzag-shaped folded filter element 13, the following modifications are possible inter alia.

The device 10 and the method are not limited to producing zigzag-shaped folded filter media webs 12 for filter elements 13 in the automotive field. Instead, they can be used also in other technical areas, for example, in industry in connection with filters for industrial motors or compressors or in water technology.

Instead of the three-layer filter medium web 12 also a filter medium web with more or fewer than three layers can be embossed, fused, and folded with the device 10 according to the instant method. For example, a composite of two mesh or netting layers and two meltblown layers can be used also in this context.

Instead of the filter medium web 12 comprising two plastic mesh layers 14 and a meltblown layer 16, other types of multi-layer filter medium webs, for example, cellulose media with meltblown laminated thereon, nonwoven with mesh laminated thereon, glass fiber media, for example, laminated glass fiber media with mesh, or air filter nonwoven can also be embossed, fused, and folded with the device 10.

It is also possible to emboss filter medium webs, connected to each other in a prior working step, by means of ultrasonic embossment unit 24 along the folding lines 36 and to thereby stably fuse them. For example, in such a prior working step in case of a filter medium web of five individual layers, two meltblown layers, for example, by means of polyurethane (PUR) hot melt, can be laminated by spray application. Subsequently, the two plastic netting layers, for example, by means of PUR hotmelt can be laminated onto the laminated meltblown layers.

The filter medium web 12 can also be heated, for example, by means of an inlet heating device, for example, for laminating the individual layers prior to feeding them to the ultrasonic embossment unit 24.

The width of the embossment webs 24 in the circumferential direction of the anvil roller 26 can also be greater or smaller than 1 mm.

The radial outer surfaces of the embossment webs 28 can also be structured instead of being smooth.

In the two embodiments, non-driven nip rollers can be provided instead of the driven nip rollers 46. It is also possible to drive only one of the two nip rollers 46.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims The invention is defined solely by the appended claims including any amendments made during the pendency of this application and all equivalents of those claims as issued.

1. A device for folding a web-shaped filter medium of a filter element, comprising:
an energy-introducing embossment unit;
a feed device configured to feed a web-shaped filter medium to the embossment unit that is configured to emboss folding lines into the web-shaped filter medium;
a folding device configured to fold the web-shaped filter medium along the folding lines;
wherein the energy-introducing embossment unit is configured to fuse layers of the multi-layer filter medium along the folding lines during embossment of the folding lines.

2. The device according to claim 1, wherein the energy-introducing embossment unit is an ultrasonic embossment unit.

3. The device according to claim 1, wherein the layers of the multi-layer filter medium are not connected to each other prior to embossment.

4. The device according to claim 1, wherein the folding device is an erecting unit that is arranged downstream of the energy-introducing embossment unit and is configured to fold the web-shaped filter medium to a zigzag-shape.

5. The device according to claim 1, wherein at least one of the layers of the multi-layer filter medium is a netting.

6. The device according to claim 5, wherein the netting is a plastic netting.

7. The device according to claim 1, wherein at least one of the layers of the multi-layer filter medium is a meltblown layer.

8. The device according to claim 1, wherein the ultrasonic embossment unit comprises an anvil roller with embossment webs, an ultrasound-operated sonotrode, and an embossment punch.

9. The device according to claim 8, wherein the embossment punch is at least partially formed by the sonotrode.

10. The device according to claim 8, further comprising nip rollers arranged in a transport direction of the filter medium before and behind the anvil roller, respectively.

11. The device according to claim 10, wherein the nip rollers are driven rollers.

12. A method for producing a zigzag-shaped folded filter element from a web-shaped filter medium, the method comprising:
feeding a web-shaped filter medium by a feed device to an energy-introducing embossment unit;
embossing folding lines into the web-shaped filter medium with the energy-introducing embossment unit and simultaneously fusing layers of the multi-layer filter medium along the folding lines; and
folding the filter medium subsequently along the folding lines by a folding device.

13. The method according to claim 12, wherein the energy-introducing embossment unit is an ultrasonic embossment unit.

14. The method according to claim 13, wherein the ultrasonic embossment unit comprises an anvil roller with embossment webs, an ultrasound-operated sonotrode, and an embossment punch.

15. The method according to claim 14, wherein the embossment punch is at least partially formed by the sonotrode.

16. A filter element produced with the device according to claim 1.

17. A filter element produced according to the method of claim 12.
